(19) United States
(12) Patent Application Publication
(10) Pub. No.: US 2011/0100539 A1
(43) Pub. Date: May 5, 2011

(54) Adhesive Label, Adhesive Label Roll, Photosensitive Web Unit, and Apparatus for and Method of Manufacturing Photosensitive Laminated Body

(75) Inventors: Kazuyoshi Suehara, Shizuoka (JP); Chiaki Suzuki, Kanagawa (JP); Nobuyasu Akiyoshi, Shizuoka (JP)

(73) Assignee: FUJI PHOTO FILM CO., LTD., Tokyo (JP)

(21) Appl. No.: 11/628,333

(22) PCT Filed: Jun. 2, 2005
(86) PCT No.: PCT/JP2005/010534

§ 371 Date: Jul. 13, 2007

(30) Foreign Application Priority Data
Jun. 4, 2004 (JP) 2004-167074
Jun. 4, 2004 (JP) 2004-167078

(51) Int. Cl. B32B 7/14; B32B 38/18; G09F 3/10

(52) U.S. Cl. 156/234; 156/390; 428/42.2

(57) ABSTRACT

A plurality of adhesive labels (10), each of a rectangular strip shape, are applied at predetermined spaced intervals to a peel-off sheet (14) of paper, which is then rolled into an adhesive label roll (12). Each of the adhesive labels (10) has a non-adhesion area (10a) centrally on a reverse side thereof facing the peel-off sheet (14), the non-adhesion area (10a) having no or weak adhesion force, and a first adhesion area (10b) and a second adhesion area (10c) which are disposed respectively on both sides of the non-adhesion area (10a).

### TECHNICAL FIELD

The present invention relates to an adhesive label for being bonded to a film having an alternate array of peel-off and residual sections to join the peel-off sections, an adhesive label roll having such adhesive labels, a photosensitive web unit having an elongate photosensitive web which comprises a photosensitive material layer and protective film that are successively laminated on a support, the protective film including predetermined lengths to be peeled off to expose areas of the photosensitive material layer for being bonded to a substrate, and an apparatus for and a method of manufacturing a photosensitive laminated body from the elongate photosensitive web.

### BACKGROUND ART

Substrates for use in liquid-crystal panels, printed wiring boards, and PDPs (plasma display panels) have a photosensitive sheet (photosensitive web) having a photosensitive material layer (photosensitive resin layer) applied to the surface of the substrate. The photosensitive sheet comprises a photosensitive material layer and a protective film that are successively laminated on a flexible plastic support.

An applying apparatus that is used to apply the photosensitive sheet to the substrate operates as follows: Substrates such as glass substrates, resin substrates, or the like are fed at predetermined spaced intervals, and lengths of a protective film (cover film) are peeled off the photosensitive sheet in alignment with respective areas of the photosensitive material layer which are to be applied to the substrate.

Japanese Laid-Open Patent Publication No. 2001-6995, for example, discloses a film applying process. According to the disclosed film applying process, as shown in FIG. 11 of the accompanying drawings, a multilayer film 1 changes its direction of travel around a direction changing roll 2 disposed closely to a cover film peeling mechanism 3. The multilayer film 1 comprises a laminated assembly of a base film 1a, a resist film 1b, and a cover film 1c. The cover film 1c has perforations 1e defined therein at predetermined spaced intervals.

The cover film peeling mechanism 3 has a sticky tape supply roll 4a for supplying a sticky tape 4, a sticky tape cutter 5 for cutting off the sticky tape 4, a swingable sticky tape pressing roll 6 for pressing the sticky tape 4 against the cover film 1c, a swingable sticky tape holding base 7 for holding the sticky tape 4 under vacuum, and a cover film takeup roll 8 for winding the cover film 1c as peeled off from the multilayer film 1. A holding roll 9a and a controlling roll 9b are disposed between the cover film takeup roll 8 and the sticky tape pressing roll 6.

The cover film 1c, which has just been peeled off from the multilayer film 1, has a trailing end to which the leading end of the sticky tape 4 is applied. When the cover film 1c is wound by the cover film takeup roll 8, it pulls the sticky tape 4 out of the sticky tape supply roll 4a. As the multilayer film 1 is fed, perforations le positioned between the cover film 1c and a remaining cover film 1d move toward a position immediately above the sticky tape pressing roll 6. Immediately before the perforations le reach that position, the sticky tape pressing roll 6 is lifted to apply the sticky tape 4 to the leading end of the cover film 1c.

While the sticky tape 4 is being attracted to the sticky tape holding base 7 under vacuum, the sticky tape holding base 7 is lowered to cause the sticky tape cutter 5 to cut off the sticky tape 4. Therefore, the sticky tape 4 is applied to the cut-off cover film 1c and the cover film 1c on the multilayer film 1 across the remaining cover film 1d. Therefore, the cover film 1c is peeled off from the multilayer film 1 and the remaining cover film 1d is kept on the multilayer film 1.

The above apparatus for performing the conventional film applying process is considerably complex in structure because the sticky tape pressing roll 6 and the sticky tape holding base 7 are vertically displaced. The direction changing roll 2 cannot firmly hold the multilayer film 1. Especially when the cover film 1c is peeled off from the multilayer film 1, peeling shocks tend to be applied to the multilayer film 1. Consequently, a laminated section of a substrate that is positioned downstream of the film applying apparatus is liable to develop a striped defective region.

Since the sticky tape pressing roll 6 presses the sticky tape 4 in linear contact therewith, the sticky tape 4 cannot firmly be applied to the cover film 1c under sufficient bonding strength. In addition, the film applying process requires complex and time-consuming maintenance for removing the adhesive material from the sticky tape cutter 5.

The film applying apparatus needs a plurality of cover film peeling mechanisms 3 arrayed in the transverse direction of the multilayer film 1 because a plurality of sticky tapes 4 need to be applied to the cover film 1c at spaced positions along the transverse direction of the multilayer film 1 for reliably peeling off the cover film 1c from the multilayer film 1. Accordingly, the film applying apparatus is large in size and costly to manufacture. Furthermore, it is necessary to install a plurality of sticky tape supply rolls 4a at spaced intervals along the transverse direction of the multilayer film 1. Replacing those sticky tape supply rolls 4a is a considerably complex process.

It has been proposed to use a sticky label having a predetermined shape, e.g., a rectangular strip shape, instead of the sticky tape 4. For example, Japanese Laid-Open Patent Publication No. 5-173487 discloses a sticky label comprising a base in the form of a heat-shrinkable plastic film or sheet and a layer of a sticky agent disposed on one surface of the base, the sticky agent having its adhesive force lowered by warm water.

The sticky label does not require usage of the sticky tape cutter 5, and hence no maintenance is needed thereof. When the unwanted cover film 1c wound by the cover film takeup roll 8 is to be discarded, the sticky label can easily be peeled off from the cover film 1c simply by being immersed in warm water.

However, if the cover film 1c is to be peeled off using the above sticky label, as shown in FIG. 11, then only the opposite ends of the sticky label need to be applied to the cover film 1c. Consequently, structures corresponding to the sticky tape pressing roll 6 and the sticky tape holding base 7 which are swingable are required, making the overall sticky label applying mechanism considerably complex.

### DISCLOSURE OF INVENTION

It is a general object of the present invention to provide an adhesive label, an adhesive label roll, and a photosensitive web unit which allow a film to be reliably and efficiently be peeled off with a simple facility and which can easily be handled.

A major object of the present invention is to provide an apparatus for and a method of manufacturing a photosensitive laminated body efficiently with a simple and economical arrangement.

According to the present invention, there is provided an adhesive label for being bonded to a film having alternately arranged peel-off sections and residual sections to join the peel-off sections to each other. The adhesive label has a non-adhesion area centrally on an adhesion surface thereof to be bonded to the peel-off sections, wherein the non-adhesion area has no or weak adhesion force and can be brought into and out of contact with at least a portion of each of the residual sections.

Preferably, the adhesive label is made of a heat-shrinkable material or the same resin material as the film. The adhesive label made of the above material can simply be reprocessed. Preferably, the adhesive label has a water-soluble sticky agent or a heat-peelable sticky agent. The sticky agent can simply be processed and has increased environment resistance.

According to the present invention, there is also provided an adhesive label roll comprising a plurality of adhesive labels each for being bonded to a film having alternately arranged peel-off sections and residual sections to join the peel-off sections to each other, and a peel-off sheet of paper wound into a roll, the adhesive labels being removably applied to the peel-off sheet at predetermined spaced intervals thereon. The adhesive label has a non-adhesion area centrally on an adhesion surface thereof to be bonded to the peel-off sections, wherein the non-adhesion area has no or weak adhesion force and can be brought into and out of contact with at least a portion of each of the residual sections.

Each of the adhesive labels is of an elongate shape, such as an elongate rectangular shape or an elongate circular shape, and has a pair of adhesive layers disposed respectively on longitudinal opposite ends of the adhesion surface for being bonded to the peel-off sections. The adhesive labels are relatively simple in structure.

According to the present invention, since the adhesive labels are used instead of an ordinary elongate sticky tape, a complex tape cutting mechanism is not required, and hence no cutter maintenance is needed. Consequently, the adhesive labels can reliably be applied with a simple and economical arrangement.

A label, bonding mechanism and a peeling mechanism are simplified in structure, and if the label bonding mechanism is separately provided, then an assembly of the adhesive labels that are bonded to the film can be handled as a unit. Such a unit can be prepared as an externally supplied unit, and finds use in a wider range of applications. In addition, the facility required to manufacture the adhesive labels and the adhesive label roll may be economically arranged.

Furthermore, since the adhesive label roll having the adhesive labels applied to the peel-off sheet is used, the adhesive labels can be handled with increased ease. A label bonding mechanism for bonding the adhesive labels is relatively simple because the adhesive labels may only be peeled off from the adhesive label roll.

According to the present invention, there is further provided a photosensitive web unit having a photosensitive web comprising a support, a photosensitive material layer disposed on the support, and a protective film disposed on the photosensitive material layer, the protective film being peelable in predetermined lengths from the photosensitive material layer to expose areas of the photosensitive material layer for being joined to substrates.

The protective film has a front peel-off section, a rear peel-off section, and a residual section interposed therebetween, with processed regions which are transversely severable being defined in the protective film at respective boundaries between the front peel-off section, the rear peel-off section, and the residual section. The photosensitive web unit further includes an adhesive label integrally bonded to the front peel-off section and the rear peel-off section across the residual section, the adhesive label having a non-adhesion area which can be brought into and out of contact with at least a portion of the residual section.

The adhesive label comprises a first adhesion area bonded to a trailing end portion of the front peel-off section, and a second adhesion area bonded to a leading end portion of the rear peel-off section, the non-adhesion area being disposed between the first adhesion area and the second adhesion area in association with the residual section. The second adhesion area projects a predetermined distance (H) (H including 0) from the boundary between the residual section and the rear peel-off section toward the residual section.

Preferably, each of the first adhesion area and the second adhesion area has a water-soluble or heat-peelable sticking agent. Preferably, the adhesive label is made of the same resin material as the protective film.

According to the present invention, there is also provided an apparatus for manufacturing a photosensitive laminated body, comprising a web reel-out mechanism for reeling out an elongate photosensitive web comprising a support, a photosensitive material layer disposed on the support, and a protective film disposed on the photosensitive material layer, the protective film having a front peel-off section, a rear peel-off section, and a residual section interposed therebetween, a processing mechanism for forming processed regions which are transversely severable in the protective film of the elongate photosensitive web reeled out by the web reel-out mechanism, at respective boundaries between the front peel-off section, the rear peel-off section, and the residual section, a label bonding mechanism for bonding an adhesive label including a non-adhesion area to the front peel-off section and the rear peel-off section across the residual section, with the non-adhesion area being disposed for being brought into and out of contact with at least a portion of the residual section, a peeling mechanism for peeling the front peel-off section and the rear peel-off section off the elongate photosensitive web while the front peel-off section and the rear peel-off section are integrally interconnected by the adhesive label, and a joining mechanism for positioning the residual section between substrates and joining, for example, by transferring or applying an exposed area of the photosensitive material layer from which the front peel-off section and the rear peel-off section are peeled off, to the substrates.

According to the present invention, there is also provided a method of manufacturing a photosensitive laminated body, comprising the steps of reeling out an elongate photosensitive web comprising a support, a photosensitive material layer disposed on the support, and a protective film disposed on the photosensitive material layer, the protective film having a front peel-off section, a rear peel-off section, and a residual section interposed therebetween, forming processed regions which are transversely severable in the protective film of the elongate photosensitive web which is reeled out, at respective boundaries between the front peel-off section, the rear peel-off section, and the residual section, bonding an adhesive label including a non-adhesion area to the front peel-off section and the rear peel-off section across the residual section, with the non-adhesion area being disposed for being brought into and out of contact with at least portion of the residual section, peeling the front peel-off section and the rear peel-off section off from the elongate photosensitive web while the front peel-off section and the rear peel-off section are integrally interconnected by the adhesive label, and positioning the residual section between substrates and joining, for example, transferring or applying an exposed area of the photosensitive material layer from which the front peel-off section and the rear peel-off section are peeled off, to the substrates.

Since the photosensitive web unit is handled, it can be handled effectively efficiently. As the peeled-off sections are integrally interconnected by the adhesive label, when the protective film is peeled off, the peeled-off sections can reliably be separated from the residual section by the peeling mechanism which is of a simple structure. The ease with which the photosensitive web unit is handled is thus increased.

Furthermore, because the adhesive label has the non-adhesion area, when the non-adhesion area is positioned on the residual section of the protective film, the front peel-off section and the rear peel-off section are integrally interconnected by the adhesive label that extends across the residual section. Accordingly, conventional swinging mechanisms and a conventional cutter mechanism which are complex are not required, and the adhesive label can be applied reliably with a simple and economical arrangement.

The label bonding mechanism and the peeling mechanism are relatively simple in structure, allowing the photosensitive laminated body to be manufactured efficiently, and making the overall manufacturing apparatus economical in arrangement.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF DRAWINGS

FIG. 1 is a perspective view of an adhesive label roll having a plurality of adhesive labels according to the present invention;

FIG. 2 is a schematic view of a manufacturing apparatus according to a first embodiment of the present invention, which employs the adhesive label roll;

FIG. 3 is a fragmentary cross-sectional view of an elongate photosensitive web used in the manufacturing apparatus;

FIG. 4 is a perspective view of a label bonding mechanism of the manufacturing apparatus;

FIG. 5 is a side elevational view of the label bonding mechanism;

FIG. 6 is a fragmentary plan view of the elongate photosensitive web with the adhesive labels applied thereto;

FIG. 7 is a fragmentary side elevational view showing the manner in which a protective film is peeled off from the elongate photosensitive web;

FIG. 8 is a fragmentary cross-sectional view of glass substrates to which a photosensitive resin layer is transferred;

FIG. 9 is a schematic view of a manufacturing apparatus according to a second embodiment of the present invention;

FIG. 10 is a perspective view of a photosensitive web unit manufactured by the manufacturing apparatus shown in FIG. 9; and

FIG. 11 is a schematic side elevational view of a conventional film applying apparatus.

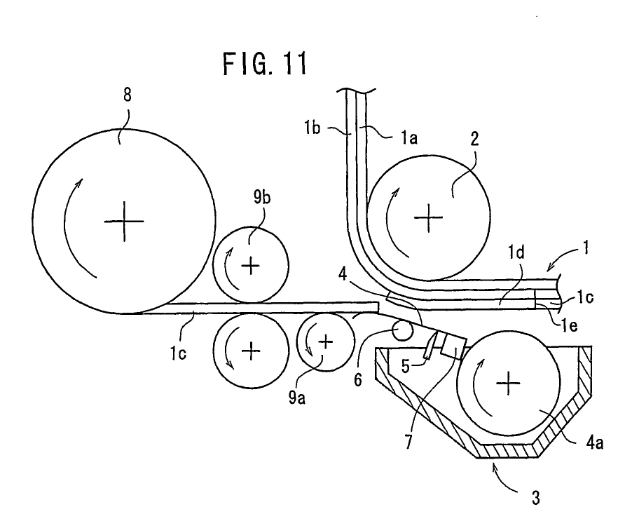

### BEST MODE FOR CARRYING OUT THE INVENTION

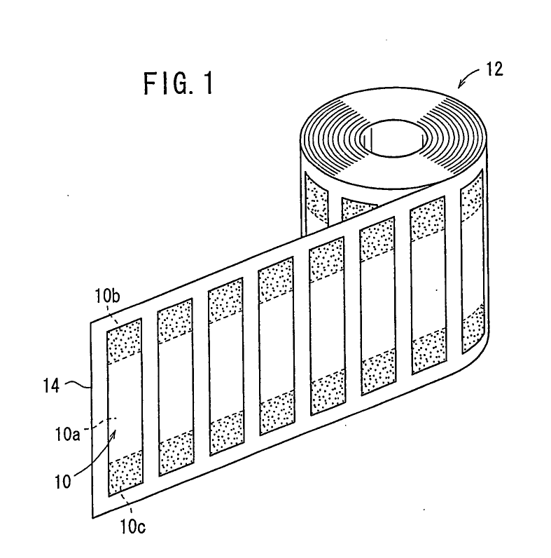

FIG. 1 shows in perspective an adhesive label roll 12 having a plurality of adhesive labels 10 according to the present invention.

As shown in FIG. 1, the adhesive labels 10, each having a rectangular strip shape, are applied at spaced intervals to an elongate peel-off sheet 14 of paper, which is rolled to form the adhesive label roll 12.

Each of the adhesive labels 10 is made of polystyrene (PS) or polypropylene (PP), for example, and has a thickness of 75 μm. Each of the adhesive labels 10 has a non-adhesion area 10a centrally on a reverse side (adhesion side) thereof facing the peel-off sheet 14, the non-adhesion area 10a having no or weak adhesion force, and a first adhesion area 10b and a second adhesion area 10c which are disposed respectively on both sides of the non-adhesion area 10a, i.e., on longitudinally opposite ends of the reverse side facing the peel-off sheet 14.

Each of the first and second adhesion areas 10b, 10c has a layer of a water-soluble acrylic sticky agent deposited to a thickness of 5 μm, the acrylic sticky agent being dissolvable in water, warm water, alkaline water, or the like. The first and second adhesion areas 10b, 10c have a bonding strength set to a range from 1 to 2N/15 mm width (20° C.) for 180° peeling with respect to polypropylene which is the material of a protective film 30 to be described later on. The first and second adhesion areas 10b, 10c may employ a heat-peelable sticky agent that can easily be peeled off with heat (see Japanese Laid-Open Patent Publication No. 7-219439, for example).

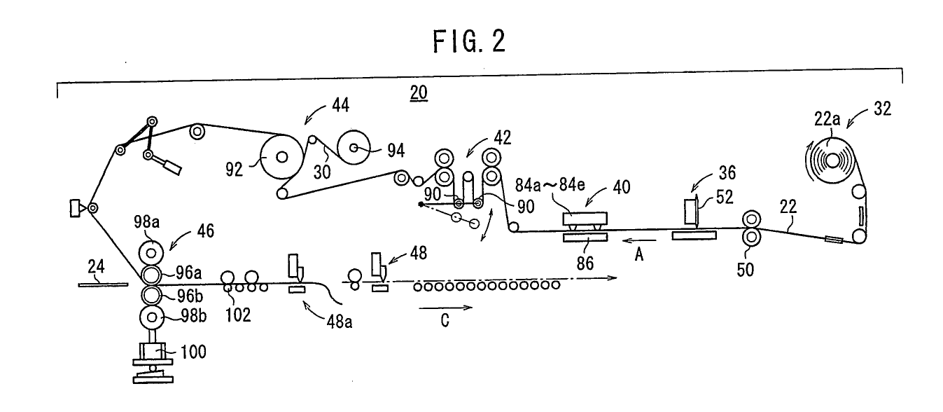

FIG. 2 schematically shows a manufacturing apparatus 20 according to a first embodiment of the present invention, which employs the adhesive label roll 12. The manufacturing apparatus 20 serves to thermally transfer a photosensitive resin layer 28, to be described later on, of an elongate photosensitive web 22 to a glass substrate 24 in a process of producing liquid-crystal panels, color filters or PDPs.

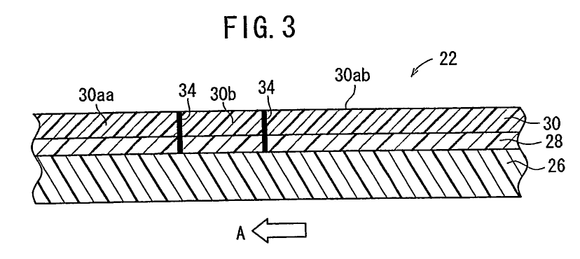

FIG. 3 shows in cross section a photosensitive web 22 that is employed in the manufacturing apparatus 20. The photosensitive web 22 comprises a laminated assembly of a flexible base film (support) 26, a photosensitive resin layer (photosensitive material layer) 28 disposed on the flexible base film 26, and a protective film 30 disposed on the photosensitive resin layer 28. For example, the protective film 30 is made of polypropylene and has a thickness of 15 μm.

As shown in FIG. 2, the manufacturing apparatus 20 comprises a web reel-out mechanism 32 for accommodating a photosensitive web roll 22a formed by rolling the photosensitive web 22 and reeling out the photosensitive web 22 from the photosensitive web roll 22a, a processing mechanism 36 for forming partly cut regions (processed regions) 34 (see FIG. 3) which are transversely severable in a protective film 30 of the photosensitive web 22 reeled out from the photosensitive web roll 22a, a label bonding mechanism 40 for bonding adhesive labels 10 (see FIG. 1) each having the non-adhesion area 10a to the protective film 30, a dancer mechanism 42 for changing the feed mode of the photosensitive web 22 from an intermittent feed mode to a continuous feed mode, a peeling mechanism 44 for peeling a predetermined length of the protective film 30 from the photosensitive web 22, a joining mechanism 46 for joining an exposed area of the photosensitive resin layer 28, from which the predetermined length of the protective film 30 has been peeled off, to a glass substrate 24, and a web cutting mechanism 48 for cutting off the photosensitive web 22 between glass substrates 24. Another web cutting mechanism 48a, which is used when the manufacturing apparatus 20 starts to operate, is disposed upstream of the web cutting mechanism 48.

The processing mechanism 36 is disposed downstream of a roller pair 50 for calculating the diameter of the photosensitive web roll 22a accommodated in the web reel-out mechanism 32. The processing mechanism 36 has a single circular blade 52 which travels transversely across the photosensitive web 22 to form a partly cut region 34 in the photosensitive web 22 at a given position thereon.

As shown in FIG. 3, partly cut regions 34 need to be formed in and across at least the protective film 30. Actually, the circular blade 52 is set to a cutting depth large enough to cut into the photosensitive resin layer 28 in order to reliably cut off the protective film 30. The circular blade 52 may be fixed against rotation and moved transversely across the photosensitive web 22 to form a partly cut region 34, or may be rotated without slippage on the photosensitive web 22 and moved transversely across the photosensitive web 22 to form a partly cut region 34. The circular blade 52 may be replaced with a laser beam or an ultrasonic cutter, a-knife blade, or a pushing blade (Thompson blade), for example.

Two processing mechanisms 36 may be provided at a spaced interval in the direction indicated by the arrow A in which the photosensitive web 22 is fed, for simultaneously forming two partly cut regions 34 with a residual section 30b interposed therebetween. The processing mechanism or mechanisms 36 may be angularly movable to give a margin to the reservoir.

Closely spaced partly cut regions 34 formed in the protective film 30 serve to set a spaced interval between two adjacent glass substrates 24. For example, these partly cut regions 34 are formed in the protective film 30 at positions that are 10 mm spaced inwardly from respective edges of the glass substrates 24. The section of the protective film 30 which is interposed between the partly cut regions 34 and exposed between the glass substrates 24 serve to prevent laminating rollers, i.e., rubber rollers 96a, 96b to be described later on, from being smeared when the photosensitive resin layer 28 is applied to the glass substrate 24 by the joining mechanism 46.

The label bonding mechanism 40 supplies adhesive labels 10 for interconnecting a front peel-off section 30aa and a rear peel-off section 30ab in order to leave the residual section 30b of the protective film 30 between the glass substrates 24. As shown in FIG. 3, the front peel-off section 30aa which is to be peeled off initially and the rear peel-off section 30ab which is to be peeled off subsequently sandwiches the residual section 30b.

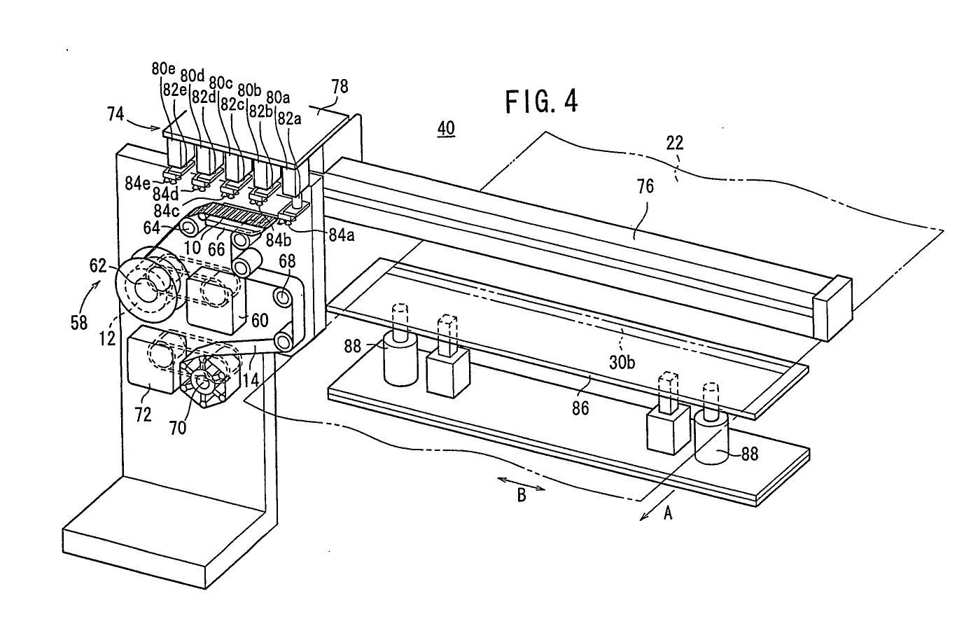

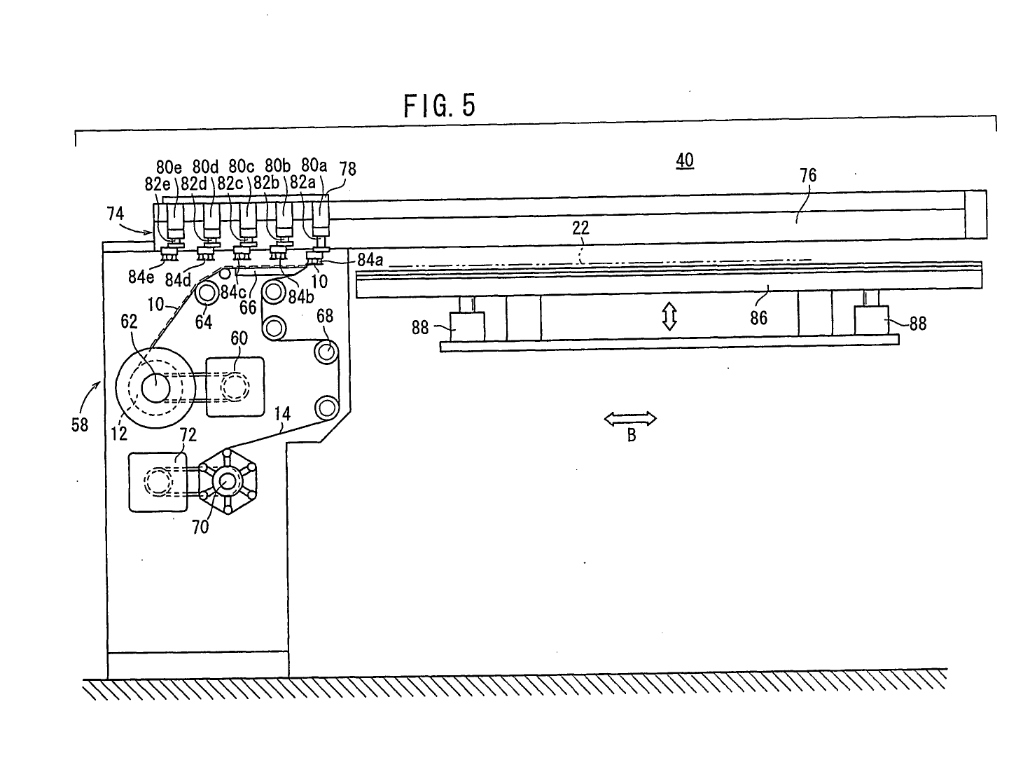

As shown in FIGS. 4 and 5, the label bonding mechanism 40 has a label reel-out unit 58 for installing therein the adhesive label roll 12 formed by rolling the peel-off sheet 14 with the adhesive labels 10 applied thereto. The label reel-out unit 58 has a rotational shaft 62 inserted axially centrally in the adhesive label roll 12 and rotatable by a motor 60. When the rotational shaft 62 is rotated by the motor 60, the peel-off sheet 14 with the adhesive labels 10 applied thereto is reeled out from the adhesive label roll 12.

The peel-off sheet 14 with the adhesive labels 10 applied thereto is fed out horizontally while being guided by a guide roller 64, and then folded back at a sharp angle by a folding member 66. The peel-off sheet 14, from which the adhesive labels 10 are peeled off ,is guided by guide rollers 68 and wound by a takeup shaft 70 that is rotated by a motor 72.

The folding member 66 is movable horizontally below a label suction feeder 74. The label suction feeder 74 has a rail 76 extending horizontally in the direction indicated by the arrow B and a self-propelled base 78 movably mounted on the rail 76. A plurality of cylinders 80a through 80e that are oriented vertically downwardly are mounted at horizontally spaced intervals on the movable base 78 and have respective piston rods 82a through 82e that support respective suction pads 84a through 84e on their lower ends.

The suction pads 84a through 84e are capable of individually holding adhesive labels 10 under suction and are capable of applying a maximum of five adhesive labels 10 at a time to the photosensitive web 22 at transversely spaced intervals thereon. The number of adhesive labels 10 that can be applied at a time to the photosensitive web 22 and the intervals at which they can be applied to the photosensitive web 22 are selected depending on the transverse dimension of the photosensitive web 22. A support base 86 that is vertically movable by cylinders 88 for holding the photosensitive web 22 from below is disposed in a position where adhesive labels 10 are applied to the photosensitive web 22 by the suction pads 84a through 84e.

As shown in FIG. 2, the dancer mechanism 42 has a pair of dancer rollers 90 which are rotatable and swingable for absorbing a speed difference between the intermittent feed mode in which the photosensitive web 22 is fed upstream of the dancer mechanism 42 and the continuous feed mode in which the photosensitive web 22 is fed downstream of the dancer mechanism 42.

The peeling mechanism 44, which is disposed downstream of the dancer mechanism 42, has a suction drum 92 for blocking variations of the tension, to which the supplied photosensitive web 22 is subjected, for thereby stabilizing the tension of the photosensitive web 22 when it is subsequently laminated. The peeling mechanism 44 also has a protective film takeup unit 94 for peeling the protective film 30, except residual sections 30b, off from the photosensitive web 22 and winding the peeled-off protective film 30. The protective film takeup unit 94 is disposed closely to the suction drum 92.

The joining mechanism 46 has a pair of vertically spaced laminating rubber rollers 96a, 96b that can be heated to a predetermined temperature. The joining mechanism 46 also has a pair of backup rollers 98a, 98b held in rolling contact with the rubber rollers 96a, 96b, respectively. The backup roller 98b is pressed against the rubber roller 96b by a pressing cylinder 100. Glass substrates 24 are fed along a substrate feed path 102 extending from the joining mechanism 46 through the web cutting mechanism 48 in the direction indicated by the arrow C.

Operation of the manufacturing apparatus 20 in relation to the adhesive labels 10 according to the present invention will be described below.

As shown in FIG. 2, the web reel-out mechanism 32 accommodates the photosensitive web roll 22a, and reels out the photosensitive web 22 from the photosensitive web roll 22a. The photosensitive web 22 is fed to the processing mechanism 36 in the direction indicated by the arrow A and is then stopped at a predetermined position.

In the processing mechanism 36, the circular blade 52 moves transversely across the photosensitive web 22 to cut into the protective film 30 and the photosensitive resin layer 28, thereby forming the partly cut region 34. Then, the photosensitive web 22 is fed again a distance corresponding to the dimension of the residual section 30b of the protective film 30, and then stopped, whereupon another partly cut region 34 is formed therein by the circular blade 52. As shown in FIG. 3, a front peel-off section 30aa and a rear peel-off section 30ab are now provided in the photosensitive web 22, with the residual section 30b interposed therebetween.

Then, the photosensitive web 22 is fed to the label bonding mechanism 40 to place a predetermined bonding area of the protective film 30 on the support base 86. As shown in FIGS. 4 and 5, the adhesive label roll 12 is mounted on the rotational shaft 62 of the label reel-out unit 58. When the motor 60 is energized, the rotational shaft 62 is rotated to reel out the peel-off sheet 14 together with the adhesive labels 10 from the adhesive label roll 12.

The peel-off sheet 14 with the adhesive labels 10 applied thereto is fed out horizontally while being guided by the guide roller 64, and then folded back at a sharp angle by the folding member 66. An edge of one of the adhesive labels 10 is peeled off from the peel-off sheet 14, and the adhesive label 10 is attracted under suction to the suction pad 84a, for example. The folding member 66 is moved to the left in FIG. 5, separating the adhesive label 10 from the peel-off sheet 14. The suction pad 84a is vertically moved by the cylinder 80a and holds the adhesive label 10 separately from the peel-off sheet 14.

The movable base 78 moves to displace the suction pads 84b through 84e to successive positions where selected ones of the suction pads 84b through 84e, e.g., all the suction pads 84b through 84e, attract respective adhesive labels 10 under suction. After the adhesive labels 10 are peeled off from the peel-off sheet 14, the peel-off sheet 14 that is folded back by the folding member 66 is guided by the guide rollers 68 to the takeup shaft 70. The takeup shaft 70 is rotated by the motor 72 to wind the peel-off sheet 14 around the takeup shaft 70.

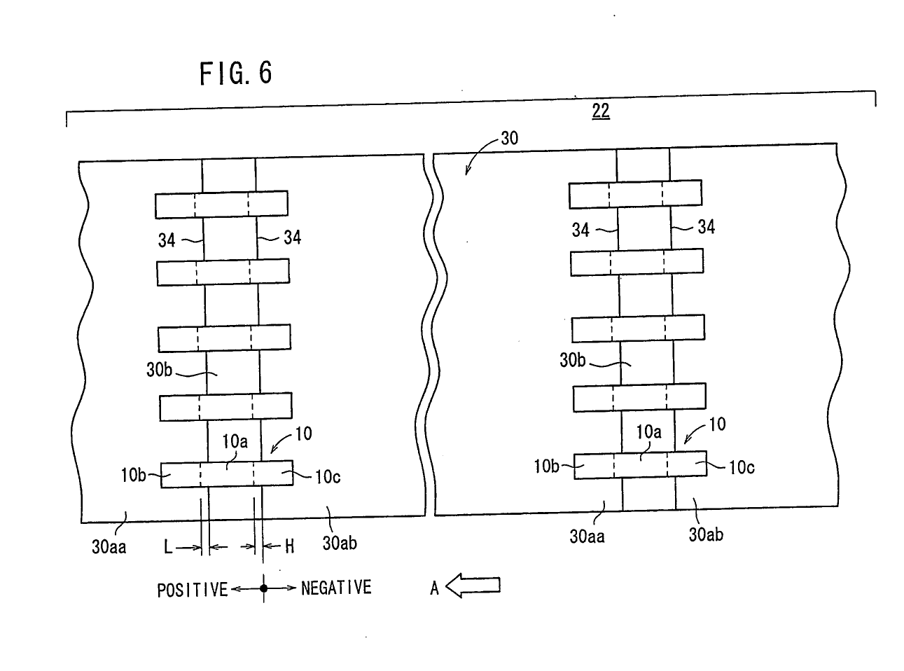

After the suction pads 84a through 84e have attracted the respective adhesive labels 10, the movable base 78 moves along the rail 76 in the direction indicated by the arrow B. The adhesive label 10 attracted by the suction pad 84a, for example, is applied to the photosensitive web 22 at a given position thereon. Specifically, as shown in FIG. 6, the adhesive label 10 is securely bonded to the front peel-off section 30aa and the rear peel-off section 30ab of the protective film 30 across the residual section 30b thereof.

The first adhesion area 10b of the adhesive label 10 is offset or retracted a predetermined distance L from the boundary between the front peel-off section 30aa and the residual section 30b toward the front peel-off section 30aa. On the other hand, the second adhesion area 10c of the adhesive label 10 projects a predetermined distance H from the boundary between the rear peel-off section 30ab and the residual section 30b toward the residual section 30b in the direction indicated by the arrow A. The distance H includes 0 (the position of the boundary).

The distance H may be changed depending on the material and thickness of the protective film 30, the state and depth of the partly cut region 34, or the dimensions and adhesion force of the adhesive label 10, and the positional accuracy of the applied adhesive label 10.

The adhesive labels 10 attracted respectively by the other suction pads 84b through 84e are applied to the photosensitive web 22 at spaced intervals. The support base 86 held against the lower surface of the photosensitive web 22 is elevated by the cylinders 88, thereby supporting the photosensitive web 22.

Then, the suction pad 84a is lowered by the cylinder 80a to press the adhesive label 10 against the photosensitive web 22. Therefore, the adhesive label 10 is reliably bonded to the photosensitive web 22. Since the adhesive label 10 is firmly held in face-to-face contact with the photosensitive web 22 by the cylinder 80a, the adhesive label 10 will not be peeled off from the protective film 30 when the protective film 30 is peeled off, unlike the conventional pressing roll system. The other suction pads 84b through 84e operate in the same manner to bond the respective adhesive labels 10 to the photosensitive web 22.

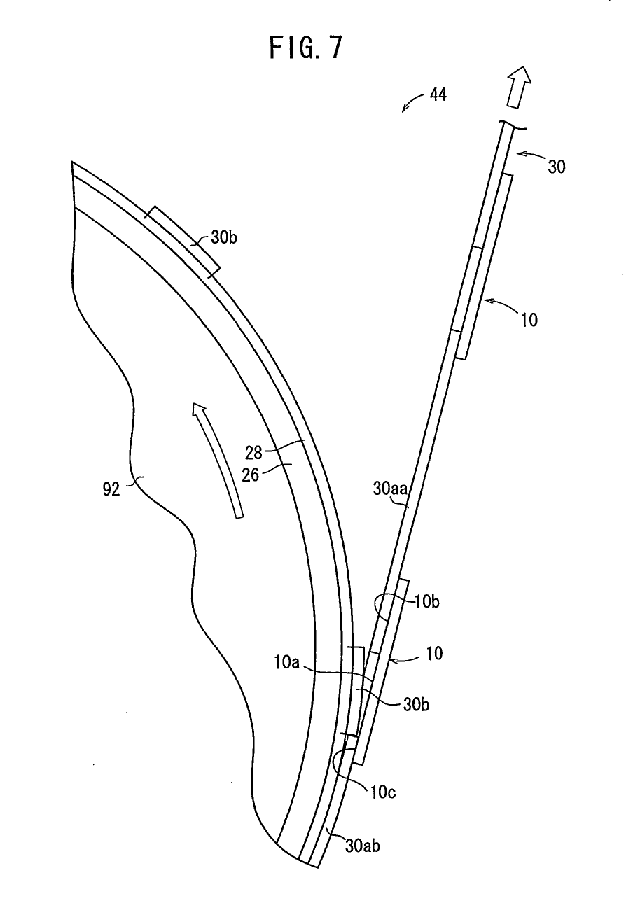

As shown in FIG. 2, the photosensitive web 22 with the five adhesive labels 10 bonded thereto is isolated by the dancer mechanism 42 from variations of the tension to which the supplied photosensitive web 22 is subjected, and then continuously fed to the peeling mechanism 44. In the peeling mechanism 44, as shown in FIG. 7, the base film 26 and the photosensitive resin layer 28 of the photosensitive web 22 are attracted to the suction drum 92, and the protective film 30 is peeled off from the photosensitive web 22, leaving the residual sections 30b on the photosensitive resin layer 28. The peeled-off protective film 30 is wound by the protective film takeup unit 94 (see FIG. 2).

At this time, inasmuch as the photosensitive web 22 is firmly held by the suction drum 92, shocks produced when the protective film 30 is peeled off from the photosensitive web 22 are not transferred to the photosensitive web 22 downstream of the suction drum 92. Consequently, such shocks are not transferred to the joining mechanism 46, and hence laminated sections of glass substrates 24 are effectively prevented from developing a striped defective region.

According to the first embodiment, the adhesive labels 10 each of a rectangular strip shape are employed. As shown in FIG. 1, each of the adhesive labels 10 has the first adhesion area 10b and the second adhesion area 10c which are disposed respectively on the longitudinally opposite ends of the reverse side (adhesion side) of the adhesive label 10 which faces the peel-off sheet 14, and the non-adhesion area 10a positioned centrally between the first and second adhesion areas 10b, 10c for association with the residual section 30b of the protective film 30.

Therefore, the adhesive label 10 with the central non-adhesion area 10a disposed for association with the residual section 30b can join the front peel-off section 30aa to the rear peel-off section 30ab through the first and second adhesion areas 10b, 10c (see FIG. 6). The label bonding mechanism 40 require only the simple suction pads 84a through 84e as major parts, but does not need the conventional swinging mechanisms and the conventional cutter mechanism which are complex. The space taken up by the label bonding mechanism 40 is reduced, and the label bonding mechanism 40 does not need cutter maintenance.

Though the label bonding mechanism 40 is of a simple and mechanical structure, it can reliably apply the adhesive labels 10 to the photosensitive web 22. The adhesive labels 10 are not limited to the rectangular strip shape, but may have rounded opposite ends or may have a central section having a mesh structure or a reduced or increased width insofar as their configurations do not obstruct the joining of the peel-off sections of the protective film 30.

According to the first embodiment, the adhesive label roll 12 with the adhesive labels 10 applied at spaced intervals to the elongate peel-off sheet 14 is employed. When the adhesive label roll 12 is fed to the label peel-off position, the suction pads 84a through 84e are selectively operated to attract a desired number of adhesive labels 10.

When the adhesive label roll 12 is consumed, a new adhesive label roll 12 may be mounted on the rotational shaft 62. It is not necessary to use a plurality of adhesive label rolls at respective bonding positions that are transversely spaced across the photosensitive web 22. As a result, the manufacturing apparatus 20 is relatively simple in its entirety, and allows a new adhesive label roll 12 to be installed with ease.

The first and second adhesion areas 10b, 10c of the adhesive labels 10 have a layer of a water-soluble acrylic sticky agent for increased environment resistance and recyclability. The protective film 30 and the adhesive labels 10 that are wound by the protective film takeup unit 94 of the peeling mechanism 44 can easily be separated from each other when they are placed in water, warm water, alkaline water, or the like. If the first and second adhesion areas 10b, 10c employ a heat-peelable sticky agent, then the protective film 30 and the adhesive labels 10 can easily be separated from each other when they are heated.

If the adhesive labels 10 and the protective film 30 are made of the same resin material and employ the same water-soluble sticky agent, then they do not need to be separated when they are discarded or recycled, and hence the discarding or recycling process is highly simplified.

If the adhesive labels 10 are made of paper (clean paper if handled in a clean room), non-woven fabric, or the like, then the adhesive labels 10 can be manufactured highly inexpensively and can be recycled simply. As the base material of the adhesive labels 10 are heat-shrinkable, they can easily be peeled off with heat in a reprocessing cycle.

According to the first embodiment, as shown in FIG. 6, the boundary between the first adhesion area 10b, which contains a sticky agent, and the second adhesion area 10c of each adhesive label 10 is spaced the distance L from the boundary between the trailing end of the front peel-off section 30aa and the residual section 30b in the direction indicated by the arrow A. Therefore, when the front peel-off section 30aa is peeled off from the base film 26, the first adhesion area 10b does not stick to the residual section 30b and does not peel off the residual section 30b.

The second adhesion area 10c of each of adhesive label 10 projects the distance H from the boundary between the leading end of the rear peel-off section 30ab and the residual section 30b toward the residual section 30b. After the front peel-off section 30aa is peeled off from the base film 26, the adhesive label 10 bonded to the front peel-off section 30aa peels off the rear peel-off section 30ab at least from its leading end. The leading end of the rear peel-off section 30ab is reliably separated from and peeled off the base film 26.

An experiment was conducted in which the rear peel-off section 30ab was peeled off with different distances H. When the distance H was of a negative value, i.e., was present rearwardly of the partly cut region 34, the rear peel-off section 30ab suffered a peeling failure. When the distance H was in excess of 4 mm, i.e., of a positive value, the rear peel-off section 30ab was bonded too strongly to the residual section 30b, tending to lift the trailing end of the residual section 30b. Therefore, the distance H should preferably be in the range from 0 mm to 3 mm.

As described above, the distance H may be changed depending on the material and thickness of the protective film 30, the state and depth of the partly cut region 34, or the dimensions and adhesion force of the adhesive label 10, and the positional accuracy of the applied adhesive label 10.

In the label bonding mechanism 40, the movable base 78 with the suction pads 84a through 84e mounted thereon moves transversely across the photosensitive web 22 to apply the adhesive labels 10. The number of adhesive labels 10 that can be applied at a time to the photosensitive web 22 and the positions in which they can be applied to the photosensitive web 22 can easily be changed depending on an increase in the tension of the photosensitive web 22 and an increase in the width of the photosensitive web 22.

After the protective film 30 is peeled off from the base film 26 by the peeling mechanism 44, leaving the residual sections 30b on the photosensitive resin layer 28, the photosensitive web 22 is fed to the joining mechanism 46. As shown in FIG. 2, glass substrates 24, which have been preheated, are successively charged at spaced intervals into the joining mechanism 46. When a glass substrate 24 is charged into the joining mechanism 46, it enters between the rubber rollers 96a, 96b while in contact with the photosensitive resin layer 28 of the photosensitive web 22. Therefore, the glass substrate 24 is gripped under a given pressure between the rubber rollers 96a, 96b, and the photosensitive resin layer 28 is melted with heat and transferred to, i.e., laminated onto, the glass substrate 24.

The photosensitive resin layer 28 is laminated onto the glass substrate 24 under such conditions that the photosensitive resin layer 28 is fed at a speed of 2.0 m/min., the rubber rollers 96a, 96b have a temperature of 130° C. and a hardness of 50, and apply a pressure (linear pressure) of 250 N/cm.

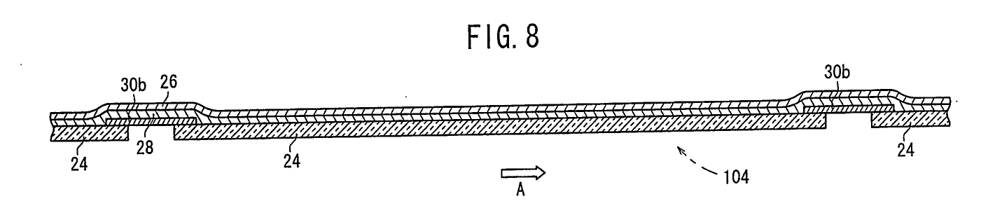

As shown in FIG. 8, the glass substrate 24 with the transferred photosensitive resin layer 28 has opposite ends covered with respective residual sections 30b. Therefore, when the photosensitive resin layer 28 is transferred to the glass substrate 24, the rubber rollers 96a, 96b are not smeared by the photosensitive resin layer 28. After the photosensitive web 22 is severed between the glass substrate 24 and the subsequent glass substrate 24 by the web cutting mechanism 48, the base film 26 and the residual section 30b are peeled off from the glass substrate 24, thus producing a photosensitive laminated body 104.

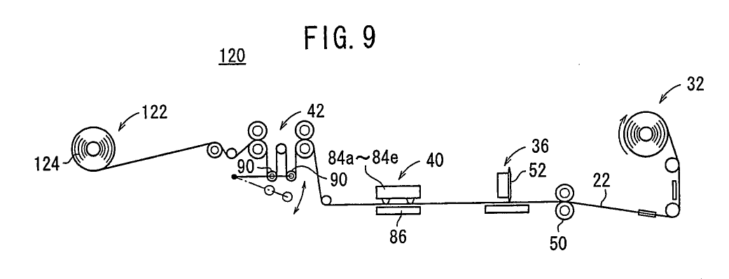

FIG. 9 schematically shows a manufacturing apparatus 120 according to a second embodiment of the present invention. Those parts of the manufacturing apparatus 120 which are identical to those of the manufacturing apparatus 20 according to the first embodiment are denoted by identical reference characters, and will not be described in detail below.

The manufacturing apparatus 120 has a web unit takeup mechanism 122 disposed downstream of the dancer mechanism 42 for winding a photosensitive web unit 124 into a roll.

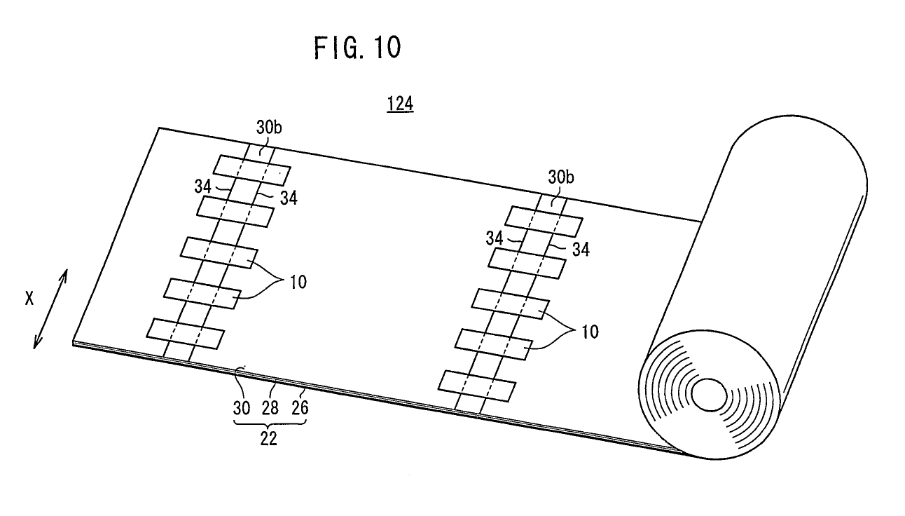

As shown in FIG. 10, the photosensitive web unit 124 has the photosensitive web 22 including the protective film 30 with partly cut regions 34 which are transversely severable. Adhesive labels 10 are bonded to the protective film 30 across the partly cut regions 34.

The manufacturing apparatus 120 operates as follows: After partly cut regions 34 are formed and adhesive labels 10 are applied, as with the manufacturing apparatus 20, the photosensitive web 22 is wound by the web unit takeup mechanism 122, thereby producing the photosensitive web unit 124.

Although not shown, a peeling mechanism installed separately from the manufacturing apparatus 120 peels off the protective film 30 from the photosensitive web unit 124, leaving residual sections 30b on the photosensitive resin layer 28. Then, the photosensitive resin layer 28 is thermally transferred to the glass substrate 24 by a joining mechanism.

According to the second embodiment, since the photosensitive web unit 124 is employed, the peeling mechanism is only required to wind the protective film 30 and hence is relatively simple in structure. Since the partly cutting device (processing mechanism) that tends to emit dust particles and tends to suffer failures is positioned separately from the peeling mechanism, a higher level of cleanness is maintained in the peeling mechanism for stabilized production. As the photosensitive web unit 124 is employed, an apparatus having the peeling mechanism and the joining mechanism may be essentially sufficient to produce substrates for use liquid-crystal panels, printed wiring boards, or PDPs economically.

Although certain preferred embodiments of the present invention have been shown and described in detail, it should be understood that various changes and modifications may be made therein without departing from the scope of the appended claims.

1. An adhesive label for being bonded to a film having alternately arranged peel-off sections and residual sections to join said peel-off sections to each other, said adhesive label having a non-adhesion area centrally on an adhesion surface thereof to be bonded to said peel-off sections , wherein said non-adhesion area has no or weak adhesion force and can be brought into and out of contact with at least a portion of each of said residual sections.

2. An adhesive label according to claim 1, wherein said adhesive label is made of a heat-shrinkable material.

3. An adhesive label according to claim 1, wherein said adhesive label is made of the same resin material as said film.

4. An adhesive label according to claim 1, wherein said adhesive label has a water-soluble sticky agent.

5. An adhesive label according to claim 1, wherein said adhesive label has a heat-peelable sticky agent.

6. An adhesive label roll comprising:
a plurality of adhesive labels , each for being bonded to a film having alternately arranged peel-off sections and residual sections to join said peel-off sections to each other; and
a peel-off sheet of paper wound into a roll, said adhesive labels being removably applied to said peel-off sheet at predetermined spaced intervals thereon;
said adhesive label having a non-adhesion area centrally on an adhesion surface thereof to be bonded to said peel-off sections , wherein said non-adhesion area has no or weak adhesion force and can be brought into and out of contact with at least a portion of each of said residual sections.

7. An adhesive label roll according to claim 6, wherein each of said adhesive labels is of an elongate shape and has a pair of adhesive layers disposed respectively on longitudinal opposite ends of said adhesion surface for being bonded to said peel-off sections.

8. An adhesive label roll according to claim 6, wherein each of said adhesive labels is made of a heat-shrinkable material.

9. An adhesive label roll according to claim 6, wherein each of said adhesive labels is made of the same resin material as said film.

10. An adhesive label roll according to claim 6, wherein each of said adhesive labels has a water-soluble sticky agent.

11. An adhesive label roll according to claim 6, wherein each of said adhesive labels has a heat-peelable sticky agent.

12. A photosensitive web unit having a photosensitive web comprising a support, a photosensitive material layer disposed on said support, and a protective film disposed on said photosensitive material layer, said protective film being peelable in predetermined lengths from said photosensitive material layer to expose areas of said photosensitive material layer for being joined to substrates,
said protective film having a front peel-off section, a rear peel-off section, and a residual section interposed therebetween, with processed regions which are transversely severable being defined in the protective film at respective boundaries between said front peel-off section, said rear peel-off section, and said residual section;
said photosensitive web unit further comprising;
an adhesive label integrally bonded to said front peel-off section and said rear peel-off section across said residual section;
said adhesive label having a non-adhesion area which can be brought into and out of contact with at least a portion of said residual section.

13. A photosensitive web unit according to claim 12, wherein said adhesive label comprises:
a first adhesion area bonded to a trailing end portion of said front peel-off section; and
a second adhesion area bonded to a leading end portion of said rear peel-off section;
said non-adhesion area being disposed between said first adhesion area and said second adhesion area in association with said residual section;
said second adhesion area projecting a predetermined distance from the boundary between said residual section and said rear peel-off section toward said residual section, said distance including 0.

14. A photosensitive web unit according to claim 13, wherein each of said first adhesion area and said second adhesion area has a water-soluble or heat-peelable sticking agent.

15. A photosensitive web unit according to claim 12, wherein said adhesive label is made of the same resin material as said protective film.

16. An apparatus for manufacturing a photosensitive laminated body, comprising:
a web reel-out mechanism for reeling out an elongate photosensitive web comprising a support, a photosensitive material layer disposed on said support, and a protective film disposed on said photosensitive material layer, said protective film having a front peel-off section, a rear peel-off section, and a residual section interposed therebetween;
a processing mechanism for forming processed regions which are transversely severable in said protective film of said elongate photosensitive web reeled out by said web reel-out mechanism, at respective boundaries between said front peel-off section, said rear peel-off section, and said residual section;
a label bonding mechanism for bonding an adhesive label including a non-adhesion area to said front peel-off section and said rear peel-off section across said residual section, with said non-adhesion area being disposed for being brought into and out of contact with at least a portion of said residual section;
a peeling mechanism for peeling said front peel-off section and said rear peel-off section off said elongate photosensitive web while said front peel-off section and said rear peel-off section are integrally interconnected by said adhesive label; and
a joining mechanism for positioning said residual section between substrates and joining an exposed area of said photosensitive material layer from which said front peel-off section and said rear peel-off section are peeled off, to said substrates.

17. An apparatus according to claim 16, wherein said adhesive label comprises:
a first adhesion area bonded to a trailing end portion of said front peel-off section; and
a second adhesion area bonded to a leading end portion of said rear peel-off section said non-adhesion area being disposed between said first adhesion area and said second adhesion area in association with said residual section;
said second adhesion area projecting a predetermined distance from the boundary between said residual section and said rear peel-off section toward said residual section, said distance including 0.

18. An apparatus according to claim 17, wherein each of said first adhesion area and said second adhesion area has a water-soluble or heat-peelable sticking agent.

19. An apparatus according to claim 16, wherein said adhesive label is made of the same resin material as said protective film.

20. A method of manufacturing a photosensitive laminated body, comprising the steps of:
reeling out an elongate photosensitive web comprising a support, a photosensitive material layer disposed on said support, and a protective film disposed on said photosensitive material layer, said protective film having a front peel-off section, a rear peel-off section, and a residual section interposed therebetween;
forming processed regions which are transversely severable in said protective film of the elongate photosensitive web which is reeled out, at respective boundaries between said front peel-off section, said rear peel-off section, and said residual section;
bonding an adhesive label including a non-adhesion area to said front peel-off section and said rear peel-off section across said residual section, with said non-adhesion area being disposed for being brought into and out of contact with at least a portion of said residual section;
peeling said front peel-off section and said rear peel-off section off said elongate photosensitive web while said front peel-off section and said rear peel-off section are integrally interconnected by said adhesive label; and
positioning said residual section between substrates and joining an exposed area of said photosensitive material layer from which said front peel-off section and said rear peel-off section are peeled off, to said substrates.

21. A method according to claim 20, wherein said adhesive label comprises:
a first adhesion area bonded to a trailing end portion of said front peel-off section; and
a second adhesion area bonded to a leading end portion of said rear peel-off section;
said non-adhesion area being disposed between said first adhesion area and said second adhesion area in association with said residual section;
said second adhesion area projecting a predetermined distance from the boundary between said residual section and said rear peel-off section toward said residual section, said distance including 0.
